(19) United States
(12) Patent Application Publication
(10) Pub. No.: US 2018/0200908 A1
(43) Pub. Date: Jul. 19, 2018

(54) PLUNGE SLITTING WITH ENHANCED SCRAP THREADING CAPABILITY USING EDGE TRIM FILLER

(71) Applicant: BUTECH, INC., Salem, OH (US)

(72) Inventor: Edward Orzel, Columbiana, OH (US)

(73) Assignee: BUTECH, INC., Salem, OH (US)

(21) Appl. No.: 15/873,071

(22) Filed: Jan. 17, 2018

Related U.S. Application Data
(60) Provisional application No. 62/447,655, filed on Jan. 18, 2017.

(51) Int. Cl. B26D 7/06; B26D 1/24; B26D 5/22; B26D 3/12; B26D 7/26; B23D 19/06

(52) U.S. Cl. CPC B26D 7/0641; B26D 1/245; B23D 19/06; B26D 3/12; B26D 7/2635; B26D 5/22

(57) ABSTRACT

A slitting machine for threading scrap material has first and second arbors; and inner rotary knives and outer rotary knives disposed on each of the first and second arbors. A pair of rolls of fill material are positioned relative to the outer rotary knives. The rolls dispense fill material onto a strip of material so that the fill material is engaged by and cut by the outer knives as well as the strip portion overlaid by the fill material to be cut by the outer rotary knives.

### CLAIM OF PRIORITY

This application claims priority from Provisional Patent Application Ser. No. 62/447,655 filed on Jan. 18, 2017, the entirety of which is hereby incorporated by reference herein.

### BACKGROUND OF THE DISCLOSURE

In processing metal coils, both ferrous and non-ferrous, slitting lines are used to reduce the width of an incoming coil by cutting it into a series of narrow coils. At the entry end of the line a coil is mounted on a mandrel and unwound. The unwound material is referred to as “strip”. The leading edge of the strip is passed through a slitting machine that slices the strip longitudinally into multiple widths (these portions are often referred to as “mults”) that are then rewound on a recoiling mandrel. The mults are then discharged and dealt with as individual narrow coils. The number of mults can vary from as little as two to as many as thirty or more.

Referring now to FIG. 1, a typical slitting machine A is shown which includes a pair of parallel arbors 10, 11 that are tooled with rotary knives 12. The knives are typically hardened steel discs, having a bore that corresponds to the arbor diameter. The knives are mounted by sliding them onto the arbor face and then spacers 13 are slid onto the arbor between adjacent knives. On a given arbor, the distance between adjacent knives establishes the width of the mult that will be produced in that zone. There is a longitudinal key (not shown) that engages the knives and also a slot in the arbor. The key serves as a way of transmitting the power (i.e., torque) from the arbor to the knives.

The upper and lower arbors 10, 11 are tooled with the same spacing between adjacent knives but the arrangement is such that the upper knives versus the lower knives are offset to each other by essentially the width of a knife. As seen in FIG. 1, all the knives 12 can be the same diameter and width. The spacers 13 between the knives can have additional “rubbers” or rubber sleeves 14 slid over the outer diameter of the spacers. The rubber sleeves 14 serve as strippers that keep the mults from wrapping themselves around the flanks of the knives. The rubber sleeves are essentially the same diameter as the outer diameter (OD) of the knives themselves.

In a parallel fashion, one of the arbors 10, 11 is adjustable relative to the other arbor such that the vertical gap between the knives can be adjusted. Typically to make a cut, the vertical gap G between the upper and lower arbors has to be adjusted just right. If the gap is too wide, the strip S will not be cut. If the gap is too small, it may result in poor cut quality (i.e., bad edges). When the strip is “cut” the cut zone includes a zone of penetration and a zone of fracture through the thickness of the strip. The amount of penetration (i.e., knife gap) required to cause the fracture, depends on strip material properties.

When the strip is cut into mults, the leading edge of the strip can cause issues with threading the leading edge through the rest of the line downstream of the slitter.

For example, the individual mult leading edges want to curl up and down, each adjacent mult curls in the opposite direction of its neighbor, thus requiring special handling during the threading of the line.

To avoid this situation, it has become common practice for operators to vary the gap between the slitting arbors. When the leading edge of the strip presents itself to the slitting machine, the gap between the upper and lower knives is adjusted too wide to effect the cut. After the leading edge is through the slitter, one of the slitter arbors is adjusted to close the gap between the upper and lower knives to a point where the material is “cut”. This technique leaves the leading edge of the strip with a length that is uncut and essentially one whole width of material thus making it much easier to thread the line. Once the line is threaded and the leading edge is close to the recoiler, the leading edge “uncut” zone is sheared off. This entire operator practice is often referred to as “plunge” slitting.

Plunge slitting is an improvement in threading the line, but it is an imperfect solution. The purpose of the present disclosure is to further improve the threading of slitting lines. In the process of slitting, in addition to the mults, the slitter also trims the outside edges (two edges) of the parent coil. This edge trimming accomplishes two things: 1) it establishes an exact width for the outermost two mults (one on each edge of the coil); and 2) it trims away bad edges from each edge of the parent coil (examples of bad edges or edges which could have cracks or could have material handling damage from prior handling of the parent coil).

Each edge trim includes a relatively narrow ribbon of scrap material. The scrap is removed from the line just downstream of the slitter. The two ribbons of scrap can be chopped into discrete scrap pieces (such was discussed in U.S. Pat. No. 7,901,271 related to scrap choppers which is hereby incorporated by reference in its entirety) or the scrap could be wound onto scrap winders.

When operators use plunge slitting, the leading edge of the strip remains uncut and includes the “scrap” edges. This requires the operator to stop the line and enter the line to physically and manually cut the scrap away from the uncut zone thus allowing the scrap to be redirected to the scrap chopper chutes or to scrap winders. This practice reduces productivity and introduces an unsafe condition for the operator.

Another problem with existing slitters is the knives are all of the same diameter so that when the scrap or trim is cut the mutt is also cut, even if it is not desired for the mult to be cut.

Thus, there is a need for a method of improving the threading of slitting lines by adding edge trim filler at the edges of the strip to enable the trim to be cut without the mults being cut which overcomes the above mentioned deficiencies while providing better overall results.

### SUMMARY OF THE DISCLOSURE

The present disclosure relates to plunge slitting. More particularly, it relates to plunge slitting with improved scrap threading capability by using edge trim filler. In accordance with one embodiment of the disclosure, a slitter and scrap chopper arrangement has knives of the same diameter while stripper rubber sleeves are positioned on spacers between the knives.

In accordance with a preferred embodiment of the disclosure, a slitting machine for threading scrap material having first and second arbors; inner rotary knives and outer rotary knives disposed on each of the first and second arbors; a pair of rolls of fill material positioned relative to the outer rotary knives; wherein the rolls dispense fill material onto a strip of material to be cut by the outer rotary knives.

In accordance with another embodiment of the disclosure, a method for threading scrap material using a slitting machine includes providing first and second arbors; providing inner rotary knives and outer rotary knives disposed on each of the first and second arbors; providing a pair of rolls of fill material positioned relative to the outer rotary knives; dispensing filler material onto an associated strip of material to allow the outer rotary knives to cut through the fill material and also cut through the strip overlaid by the fill material.

Another aspect of the disclosure is to prevent the two trimmed scrap edges from fouling on the scrap chutes that are close coupled to the exit side of the slitter. In any slitting line, scrap chopper chutes need to be close coupled to the exit of the slitter arbors otherwise the scrap system is not self-threading.

In accordance with another aspect of the disclosure, the slitter arbors close while the strip is moving. This relates to the ratio of the rate of arbor closure vs. strip travel and can be implemented as an automatic sequence controlled by the operator.

When the leading edge of the strip is at the nip of the slitter arbors, the arbor gap is commanded to close at a predetermined rate while the strip advances (continues to feed past the slitter) at an appropriate line speed, such that after 2 feet, more or less has passed through the nip of the slitter arbors, the slitter arbor vertical gap has closed to a point where the knife vertical gap is tight enough to cut through the strip. This can be a fully automated sequence or can be manual with the operator controlling the sequence. The key is the timing between the vertical closure of the arbors and the speed of advance of the strip.

As the arbor gap closes it is important for the strip to be advancing otherwise the separating force between the arbors would get quite large and possibly overload the slitter arbor bearings.

In accordance with still another embodiment of the disclosure, strip material is fed into the line and the slitter arbor gap is preset too large to make the cut (i.e., during initial threading through the slitter).

In accordance with another embodiment of the disclosure, spools of edge trim filler material are mounted above the slitter arbors on a parallel shaft.

In accordance with another embodiment of the disclosure, the filler material is chip board, an inexpensive high compressive strength but flexible material.

In accordance with another embodiment of the disclosure, the spools are aligned such that when dispensed the filler material (chipboard) will straddle the cutting zone of the edge trim or scrap.

In accordance with another embodiment of the disclosure, at the outer pair of knives; one pair at each of the two outside edges, the extra thickness of the filler material increases the apparent thickness of the strip; thereby pushing the strip deeper against the lower knife and the scrap/trim is cut through without the mults being cut.

In accordance with another embodiment of the disclosure, the filler material is overlaid on the strip in the “uncut” zone, therefore the trim is cut through, but not the mults.

In accordance with another embodiment of the disclosure, after a predetermined distance, the filler/chipboard is cut off and no more is dispensed onto the strip. In this manner, the scrap (trim) is cut all the way through and threads itself into the scrap chutes.

In accordance with another embodiment of the disclosure, each of the above described functions can be automated.

Other aspects of the disclosure will become apparent upon a reading and understanding of the following detailed description.

### BRIEF DESCRIPTION OF THE DRAWINGS

FIG. 1 is a perspective view of an existing slitter and scrap chopper assembly;

FIG. 2 is a perspective view of a slitter, and scrap chopper using edge trim filler in accordance with a preferred embodiment of the disclosure;

FIG. 3 is a top plan view illustrating the use of filler material with the slitter assembly of FIG. 2;

FIG. 4 is a side elevational view in cross-section illustrating the edge from filler being fit through the knives of FIG. 3;

FIG. 5 is a front elevational view of the knives of the slitter assembly of FIG. 3;

FIG. 5A is an enlarged front elevational view of edge trim filler fit through the knives along detail of FIG. 5.

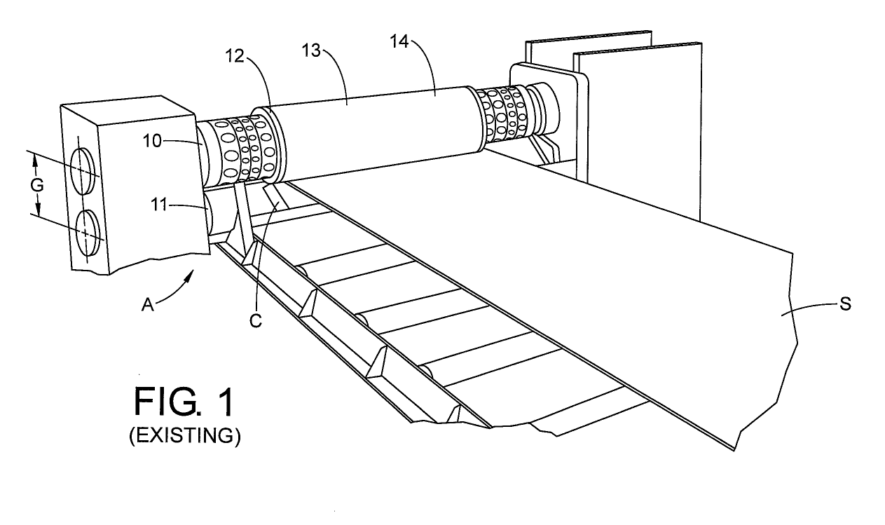

### DETAILED DESCRIPTION OF THE DISCLOSURE

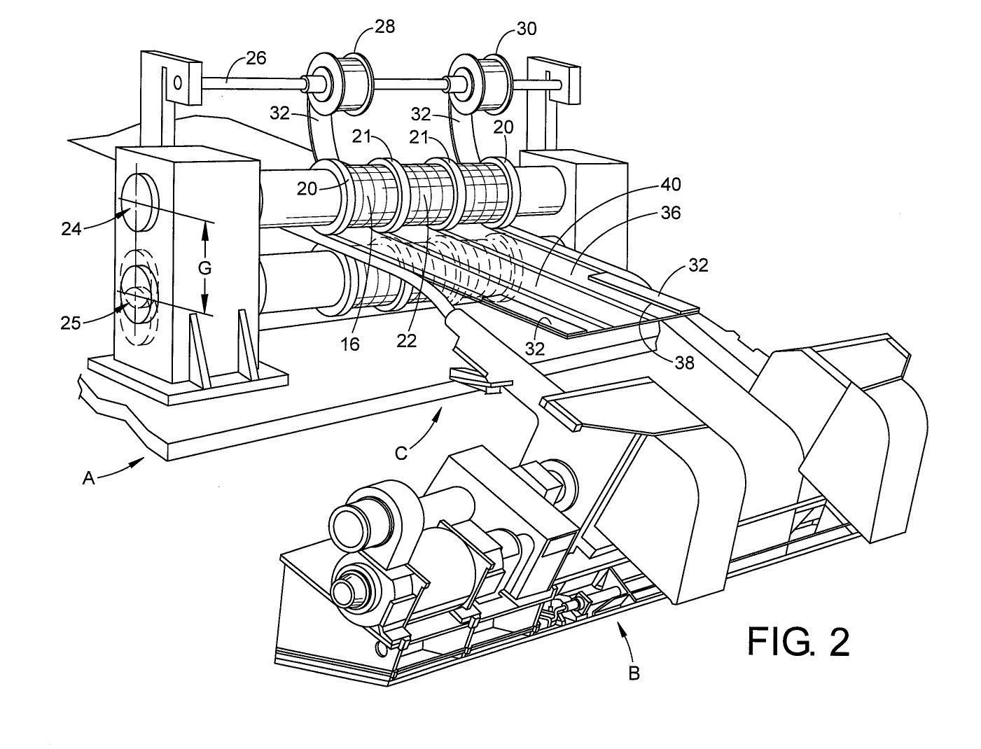

The present disclosure relates to plunge slitting. More particularly, it relates to plunge slitting with improved scrap threading capability by using edge trim fillers. The present disclosure is shown as FIGS. 2 through 5A.

Referring now to FIG. 2, a slitter A and scrap chopper B and scrap chute C arrangement are shown. The slitter and chopper are shown separately for clarity. The scrap chopper is shown to illustrate the problem of how to get the scrap trim into the chopper where the first two feet, or more or less, of strip is not cut through. The same problem exists regardless whether a scrap chopper or scrap winder is used. All of the knives 20 are of the same diameter while stripper rubber sleeves 22 are positioned on spacers 16 between the knives.

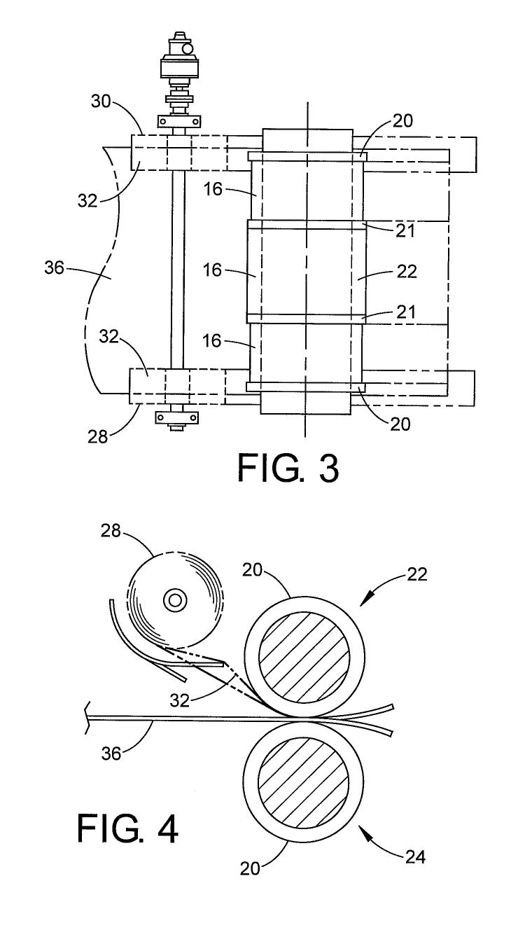

Referring now to FIGS. 2 and 3, in accordance with a preferred embodiment of the disclosure, mounted above the parallel slitter arbors 24, 25 is a parallel shaft 26 that has two parallel spools 28, 30 of edge trim filler material 32, such as chip board (an inexpensive high compressive strength but flexible material). However, other suitable materials may also be used. The spools are aligned and are parallel to outer knives 20 and inner knives 21 such that when dispensed the filler material 32 or chip board will straddle or overlay the uncut zone 38 of the trim or scrap 36.

During plunge slitting, the gap between upper and lower knives is initially too large to cut the strip 36 into mults 38. The gap G between the arbors can be adjusted since lower arbor 25 can be raised or lowered in relation to upper arbor 24 (See FIG. 2). At the outer pair of knives 20; one pair at each of the two outside edges of the strip, the extra thickness of the chipboard 32 (filler material) increases the apparent thickness of the strip 36; thereby pushing the strip deeper against the lower knife 20 and the scrap or edge trim is cut through. That is, the filler material is overlaid on the strip in the “uncut” zone 38, therefore the trim is cut through, but not the mults 40. After a predetermined distance, the filler/chipboard is cut off and no more is dispensed onto the strip. In this manner, the scrap (trim) is cut all the way through and threads itself into the scrap chutes (for clarity, not shown). This overcomes the shortcomings of existing practice. Once the filler material is close being overlaid onto the strip, then the arbors 24, 25 can be further closed to allow inner knives 21 to cut the mults 40 within the center portion of the strip.

Referring to FIGS. 3 and 4, a spool 28 of filler material 32 (such as chipboard) is shown positioned above arbors 24, 25 and being spooled onto the strip 36 and between knives 20.

If the above gap G is too wide to slit; i.e., breakthrough the strip, the other cuts also will not break through. The filler ribbon or chip board 32 increases the apparent thickness of strip under the trim knives thereby pushing the strip deeper against the lower knives and the trim actually cuts through. After a predetermined distance the filler or board is cut. All of the functions disclosed above can also be automated.

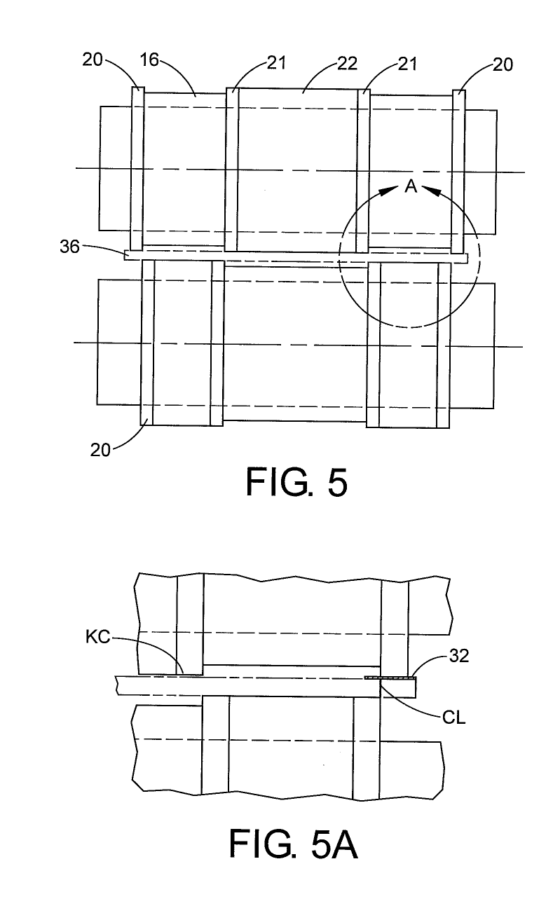

Specifically, referring to FIGS. 5 and 5A, as the arbor gap G is closed, the knives 20 still have a gap or knife clearance KC with the strip. However, the edge trim filler material 32 at the outer edges of the strip form a cut line CL since they increase the overall “thickness” of the strip and thereby drive the knives 20 through the strip with the trim and filler is cut through. By doing this, no additional mults are cut toward the center of the strip. If the arbor gap G is further closed, then the inner mults 40 can be slit or cut using inner knives 21.

The disclosure has been described with reference to a preferred embodiment. Obviously, modifications and alterations may occur to others while reading and understanding the preceding detailed description. It is intended that the disclosure includes all such modifications and alterations insofar as they come within the scope of the appended claims and the preceding description.

1. A slitting machine for threading scrap material comprising:
first and second arbors;
inner rotary knives and outer rotary knives disposed on each of said first and second arbors;
a pair of rolls of fill material positioned relative to said outer rotary knives;
wherein said rolls dispense fill material onto an associated strip of material to be cut by said outer rotary knives.

2. The slitting machine of claim 1, whereas spacers are positioned between said inner and outer rotary knives.

3. The slitting machine of claim 2, wherein sleeves are placed over said spacers.

4. The slitting machine of claim 1, wherein said arbors are adjustable to change a gap between said first and second arbors.

5. The slitting machine of claim 1, wherein said rolls of fill material are mounted onto a shaft parallel to said first and second arbors.

6. The slitting machine of claim 4, wherein said rolls dispense fill material and overlay said fill material onto opposite edges of said associated strip of material as said strip passes through said slitting machine.

7. The slitting machine of claim 6, wherein said gap between said first and second arbors is closed while the associated strip travels through the slitting machine so that a gap between said outer rotary knives is small enough so that the outer rotary knives engage and cut through said fill material overlaying said strip and a portion of said strip on which said fill material is overlaid.

8. The slitting machine of claim 7, wherein said gap is too large for said inner knives to contact and cut said strip.

9. The slitting machine of claim 8, wherein said gap between said first and second arbors is further closed thus engaging said inner knives with said strip to cut mults within a central portion of said strip.

10. The slitting machine of claim 1, wherein said fill material is chipboard.

11. The slitting machine of claim 1, wherein a scrap chopper and chute are positioned at an end of said slitting machine.

12. A method for threading scrap material using a slitting machine comprising:
providing first and second arbors;
providing inner rotary knives and outer rotary knives disposed on each of said first and second arbors;
providing a pair of rolls of fill material positioned relative to said outer rotary knives;
dispensing fill material onto an associated strip of material to allow said outer rotary knives to cut through said fill material and cut through said strip overlaid by said fill material.

13. The method of claim 12, wherein said first and second arbors are adjustable to change a gap between said first and second arbors.

14. The method of claim 12, wherein said rolls of fill material are mounted onto a shaft parallel to said first and second arbors.

15. The method of claim 12, wherein said rolls dispense fill material and overlay said fill material onto opposite edges of said associated strip of material as said strip passes through said slitting machine.

16. The method of claim 13, wherein said gap between said first and second arbors is closed while the associated strip travels through the slitting machine so that a gap between said outer rotating knives is small enough so that the outer rotary knives engage and cut through said fill material overlaying said strip and a portion of said strip overlaid by said fill material.

17. The method of claim 16, wherein said gap is further closed so that said inner knives engage and cut mults in a central portion of said strip.
